(19) United States
(12) Patent Application Publication
(10) Pub. No.: US 2015/0172227 A1
(43) Pub. Date: Jun. 18, 2015

(54) AUTOMATED USER CHAT APPLICATION THAT CREATES CHAT SESSIONS BASED ON KNOWN USER CREDENTIALS AND BEHAVIORAL HISTORY

(71) Applicant: NutraSpace LLC, Grand Prairie, TX (US)

(72) Inventor: Dean Franklin Grove, II, Tulsa, OK (US)

(73) Assignee: NutraSpace LLC, Grand Prairie, TX (US)

(21) Appl. No.: 14/106,732

(22) Filed: Dec. 14, 2013

(51) Int. Cl. H04L 12/58

(52) U.S. Cl. CPC H04L 51/04

(57) ABSTRACT

Identifying the information associated with a number of different user accounts may provide the basis for automatically generating a chat session based on that information. In one example method of operation a number of users may be identified as potential candidates for a chat session via an automated agent application and an attribute of each of the users may be retrieved from memory that shares a common interest identifier with the other users. The chat session can then be created based on the common interest identifier, and a notification can be transmitted to each of the users to invite them to the chat session.

### TECHNICAL FIELD OF THE APPLICATION

This application relates to identifying user credentials and activity via profile, social networking and other information sources and creating new information and chat sessions to increase interactions among users with similar interests and credentials.

### BACKGROUND OF THE APPLICATION

Conventionally, when a user accesses a chat room or other social networking website/application the user may identify a topic of interest such as a forum or chat room topic. The user may then observe postings made by certain individuals in an effort to increase traffic and postings regarding a topic, a link, a picture, a video, etc. The entire model of FACEBOOK® is based on one gigantic blog that dynamically changes from posting to posting.

However, little to no focus is ever presented to users who are seeking information about specific topics. Additionally, the users are not able to connect with strangers who have the same interests and are only able to view the postings of their immediate network of individuals or those connected to their network through those predetermined individuals.

### SUMMARY OF THE APPLICATION

One example embodiment of the present application may provide a method that includes identifying the information associated with a number of different user accounts and automatically generating a chat session based on that information. In one example method of operation, a number of users may be identified as potential candidates for a chat session via an automated agent application, and an attribute of each of the users may be retrieved from memory that shares a common interest identifier with the other users. The chat session can then be created based on the common interest identifier, and a notification can be transmitted to each of the users to invite them to the chat session.

Another example embodiment of the present application may include an apparatus that provides a processor configured to identify a plurality of users as potential candidates for a chat session via an automated agent application, retrieve at least one attribute of each of the plurality of users with a common interest identifier from a memory, and create the chat session based on the common interest identifier. The apparatus may also include a transmitter configured to transmit a notification to each of the plurality of users to invite them to the chat session.

### BRIEF DESCRIPTION OF THE DRAWINGS

FIG. 1 illustrates an example logic diagram of a chat session setup and configuration according to example embodiments of the present application.

FIG. 2 illustrates an example user interface and chat session configuration according to example embodiments.

FIG. 3 illustrates an example logic diagram of chat session information retrieval and operation according to example embodiments of the present application.

FIG. 4 illustrates an example flow diagram of an example method of operation according to example embodiments of the present application.

FIG. 5 illustrates an example system communication diagram of a communication session according to example embodiments of the present application.

FIG. 6 illustrates an example system configuration of chat session creation device(s) according to example embodiments.

FIG. 7 illustrates an example network entity device configured to store instructions, software, and corresponding hardware for executing the same, according to example embodiments of the present application.

### DETAILED DESCRIPTION OF THE APPLICATION

It will be readily understood that the components of the present application, as generally described and illustrated in the figures herein, may be arranged and designed in a wide variety of different configurations. Thus, the following detailed description of the embodiments of a method, apparatus, and system, as represented in the attached figures, is not intended to limit the scope of the application as claimed, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present application, the application may be applied to many types of network data, such as, packet, frame, datagram, etc. For purposes of this application, the term “message” also includes packet, frame, datagram, and any equivalents thereof. Furthermore, while certain types of messages and signaling are depicted in exemplary embodiments of the application, the application is not limited to a certain type of message, and the application is not limited to a certain type of signaling.

Example embodiments provide an application that creates chat sessions, social networking affiliations, topics of interest and other online tools to engage users with certain interests to communicate and share information without the user having to create a new chat session, invite participants, setup a time, propose a topic, etc. Example embodiments also include ways to increase the quality of the chat sessions by rewarding participants or incentivizing participants for participating, sharing certain information, etc. Also, certain participants may be eliminated who are offensive or who produce spam and otherwise not contributing to the goal of the session. In one example, a helpful and productive participant may be approved by others to increase their overall use score and receive points. The total points may be applied to a rewards system, or the points may be displayed to other users to increase comradery among users.

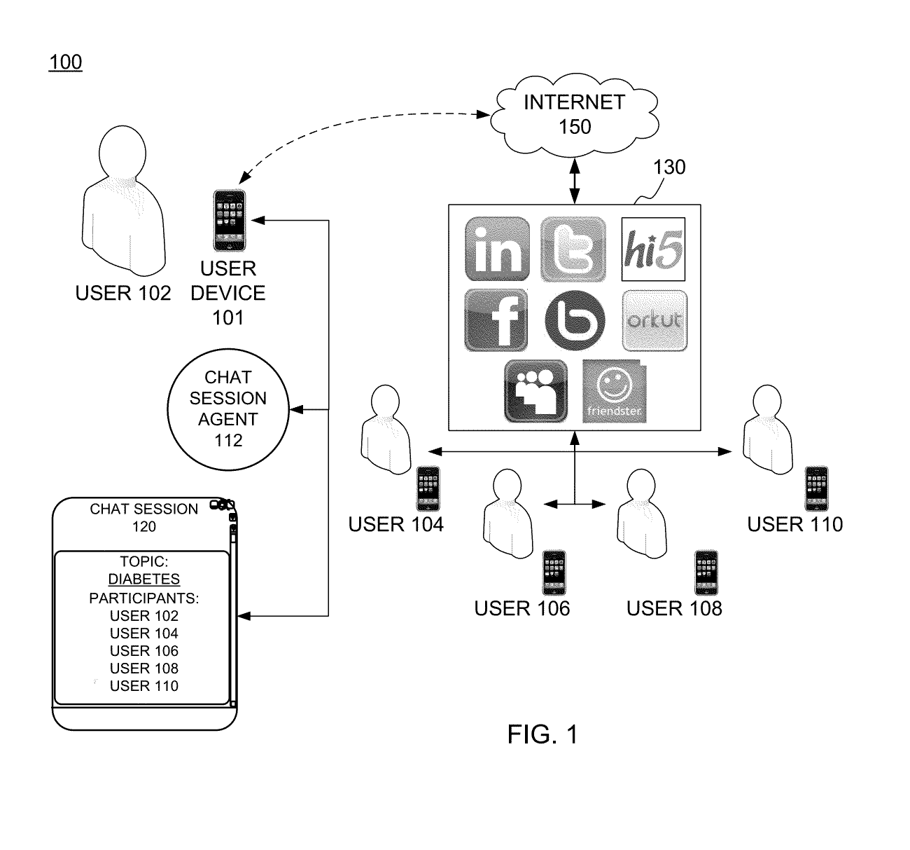

FIG. 1 illustrates an agent process and corresponding chat session establishment according to example embodiments. Referring to FIG. 1, the chat session setup configuration 100 includes a user 102 operating a user device 101. The device may be a computer, laptop, mobile, wireless or cellular phone, a PDA, a tablet, a client a server or any device that contains a processor and/or memory, whether that processor or memory performs a function related to an embodiment of the application.

In operation the device may connect to a data network via a WIFI or 3G/4G data communication network. The data network may include the Internet 150 or other user accessible network. The users 104, 106, 108 and 110 may represent other users operating users devices which are accessible over the network. The actions performed and the history of the users may be accessible via any of the commonly known social networking platforms 130, such as LINKEDIN, TWITTER, HI5, FACEBOOK, ORKUT, MYSPACE, FRIENDSTER, BEBO, etc. Each of the users 102, 104, 106, 108 and 110 may have corresponding profiles with certain history including, conversation, preferences, favorites, age and profile, RSS feeds, etc. The information stored in those profiles may be reviewed and shared with the chat session agent 112, which may be an application installed on the user device and/or a remote server.

In operation, the agent 112 may identify the user attributes, likes, conditions, etc., and may begin by clustering users with similar attributes, which may include, location in the world (e.g., Boston, New York, San Diego, etc.), similar known likes and dislikes (e.g., Rock music, hip hop music, etc.), chronic conditions (e.g., cancer, diabetes, arthritis, etc.), time zones, and/or activity levels. Once a cluster reaches a particular threshold necessary for useful conversation and chat session to be successful a certain notification may be generated by the chat session agent which monitors thresholds, creates chat sessions and performs corresponding maintenance on those sessions. In the example of FIG. 1, a chat session may be created by the chat session agent 112 operating as an add-on application to a particular blog site or used to monitor all social networking activity of a user or for select sites and topics. The agent 112 may identify the most popular topics of a user 102, such as cancer, diabetes, retirement savings for someone who is middle-aged or older. The chat session may then be created to accommodate the user's interests and those of other users. For example, the cluster may be preconfigured for 10-12 users who are located in the same time zone and state, the users are all identified as having a high likelihood of interest in the topic of diabetes. As a result, the chat session agent may create the session 120 and invite five participants 102, 104, 106, 108 and 110 as all potential candidates to attend the live session.

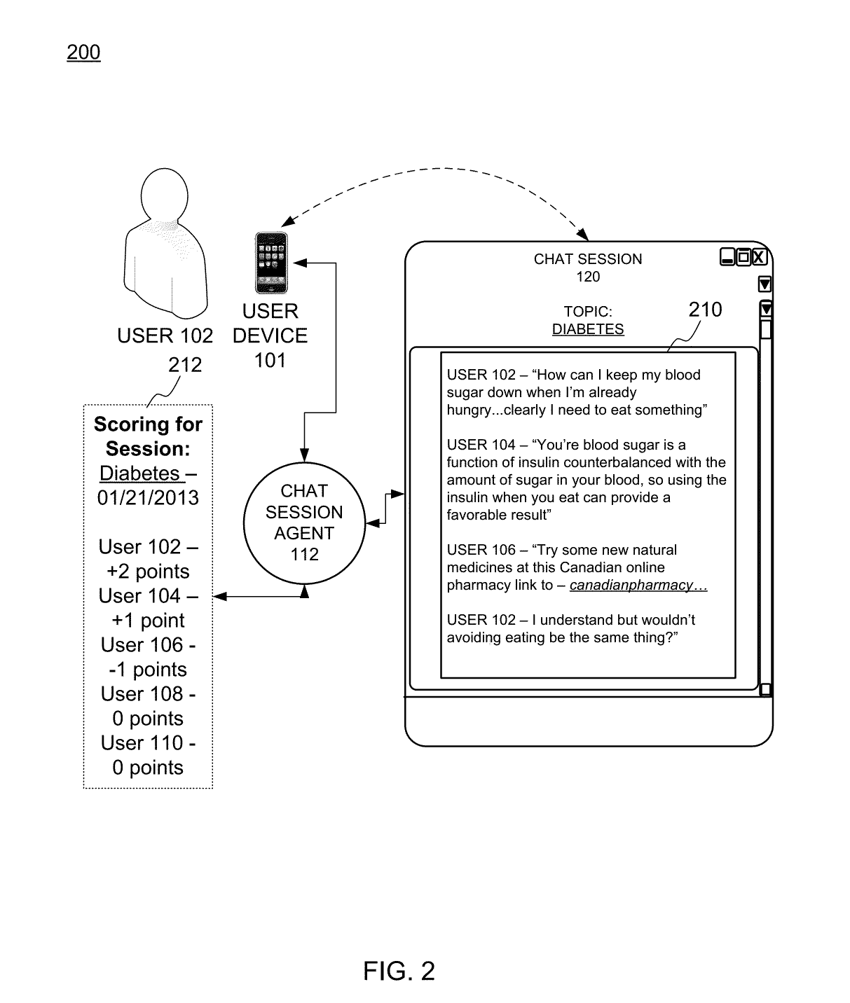

FIG. 2 illustrates additional details of the chat session creation application according to example embodiments. Referring to FIG. 2, the example 200 includes a user 102 and device 101 similar to FIG. 1 and the chat session 120 may be underway and include various users who were invited and have since accepted the invitation and entered the live session which may be scheduled for a certain day and time. The session content 210 may include various user comments and statements made by the user devices and transmitted to the session server where the information is shared with the user devices individually. The scoring for the session 212 may be performed by the session agent 112, the scoring may provide a way to rank users, include/exclude users in current/subsequent chat sessions and offer future recommendations to those users. The agent may offer the users access to a disease/interest specific chat session at a future time/date based on their current use and points. The user 102 may be one of five users who are attending the session based on a confirmation message and identification of the invited users. In this example, the user 102 is receiving points for sharing topic related information, and the user 104 is also receiving points, although not at the same rate as user 102 who has shared more at this point in the chat session. The user 106 has lost a point (−1) for adding spam to a website that is not contributing to the topic or the discussion. The users 108 and 100 are neutral and have yet to offer any information.

Before the session begins, the agent 112 may identify a notification that is topic related and transmit the notification to the intended recipients. For example, once the threshold of chat session establishment has been reached, a notification may be created and transmitted to each of the potential candidates that states: “Would you like to join a chat session about ‘Managing Diabetes’ with other Health Agent users that are interested in ‘Diabetes’?” If any of the users selects ‘Yes’, then the agent 112 may generate a selection of times and days to determine when the user might be available and transmit one or more options to the user for acceptance. The user may select one or more of the times/days and then receive a reminder or calendar update that the session is scheduled at a particular time based on the selections received from the various invitees. If a user selects “No”, the likelihood they will be offered future chat sessions may decrease by some margin, similar to the point system 212 in FIG. 2, the user may lose a point or gain or lose nothing while a user accepting a session may gain a point which is added to their profile for future reference.

In another example, the agent 112 calculates the number of chat sessions required, the optimal time/day of the user, and if a user's constraints cannot be satisfied the agent may attempt to explain a reason why and offer the user alternative times/days of chat sessions that satisfy other users. For example, an agent may request 3 chat sessions for 35 users, dividing users into groups that are near optimal for chat conversations (i.e., <13), at 3 different times, satisfying the constraints of 34 users. When one particular user's constraints are not satisfied, the agent explains why their selected time/date is not available and informs them about the current three meetings that are successfully scheduled to determine if that user can join those meetings.

The agent 112, then transmits an email of a meeting link to the user(s) and also pins the suggestion electronically to the top of recommendations for ‘X’ hours leading up to the chat session. This operation may be unique per chat room and for private information so that additional members or anonymous users do not join the session. When users join the chat session they are prompted with discussion topics and moderators can be selected from reputable members of the community in the future. The chat will continue until everyone has left the chat session.

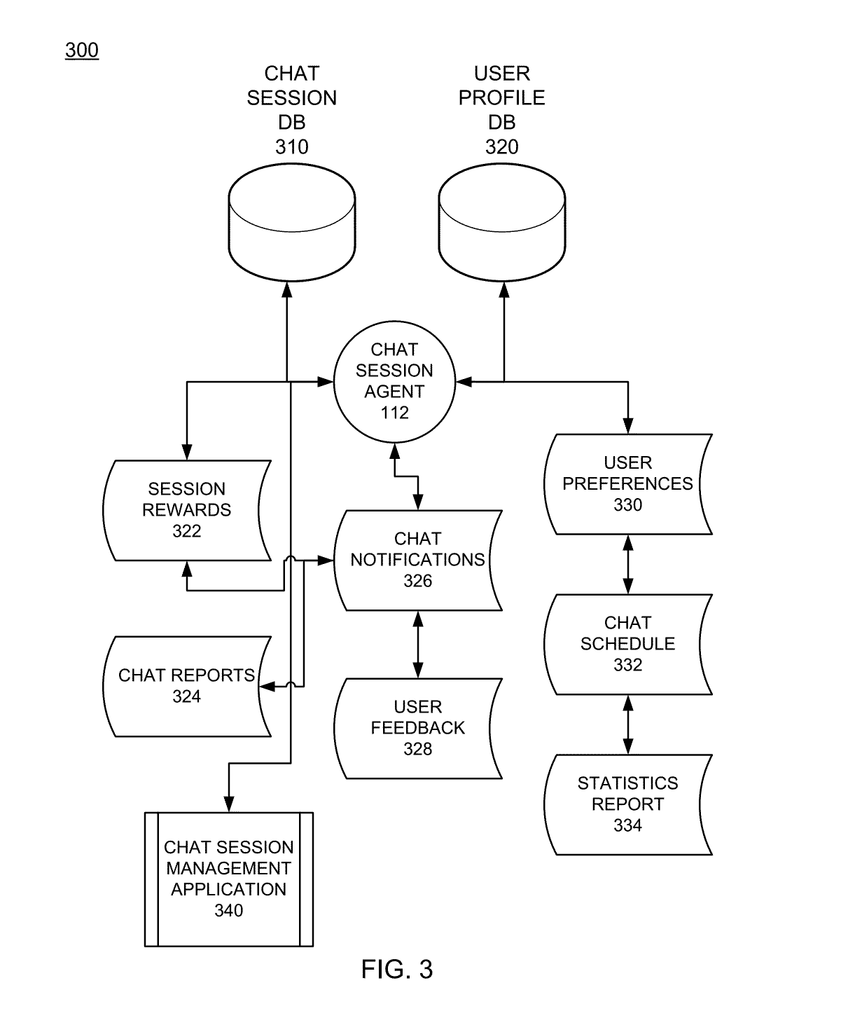

FIG. 3 illustrates an example chat session creation and information logic diagram according to example embodiments. Referring to FIG. 3, the logic diagram 300 includes a chat session agent 112 operating as an application that utilizes user information to create chat sessions. The information used to create chat sessions may be based on two primary data sources including information from previous chat sessions and scheduled chat sessions which may be stored in a first database 310. That information may include content of previous chats, chat topics, users who attended chat sessions, topics included in the chat sessions, etc. The other information source may be a second database 320 that stores and retrieves user profile information obtained from user emails, user posts, user preferences and user account information from third party social networking databases. The databases may be separate or part of the same server database. The chat session agent may use the database information to create, schedule, invite users, and update the chat sessions for the current and future chat sessions conducted.

Information sources used to support current chat sessions may include session rewards 322 which may be points that are added/deleted to each user account based on the user's activity with the chat sessions. The chat notifications 326 may be created and transmitted to each of the users when a chat session is scheduled. The user preferences 330 may be retrieved and use to identify chat session topics, a chat schedule and to identify if a particular user is a good candidate or not for a particular chat session. The chat schedule 332 may be used to generate the notifications and maintain chat initiation efforts. Chat reports 324 may be generated to tally the chat user sessions and corresponding scores and promotions/demotions for each user. The user feedback 328 may be received and stored to perform future chat sessions and to identify users who like/dislike the session. The statistics report 334 may be generated to identify a success or failure of particular chat so future chat sessions can be improved. The chat session management application 340 may compile all of the information received by the agent 112 and use that information to increase chat session success and to modify previous settings to increase the generation of new chat sessions.

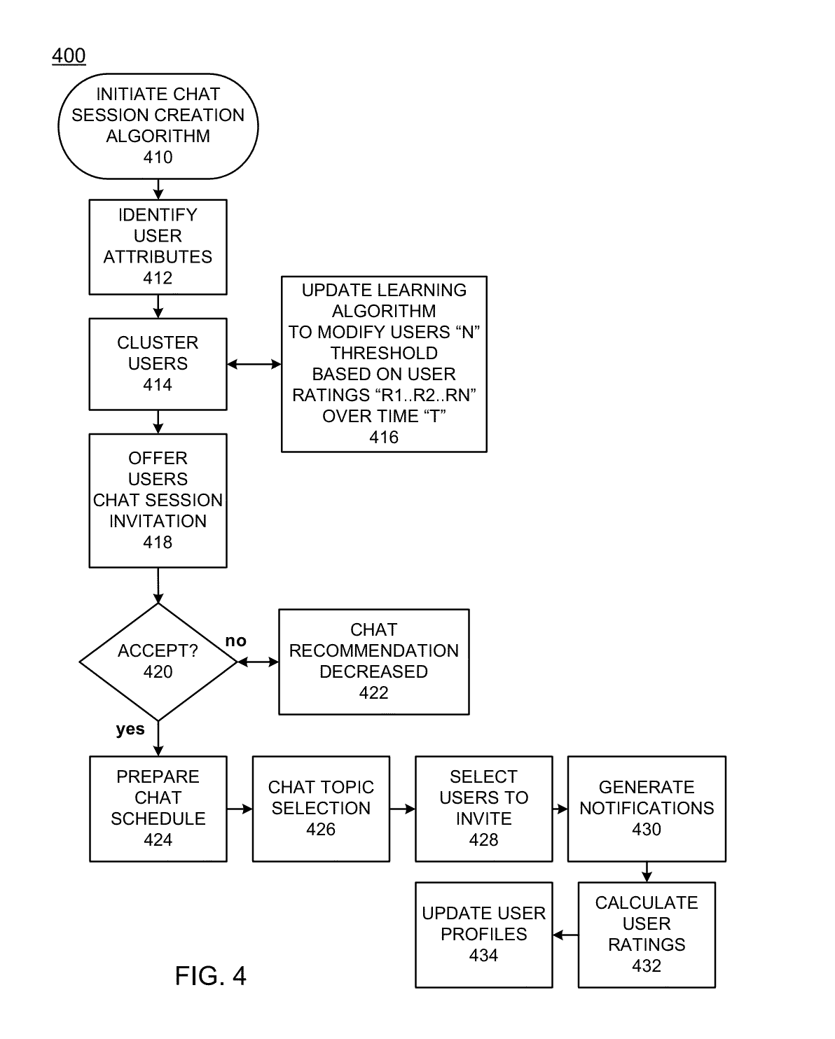

FIG. 4 illustrates a flow diagram of an example method of operation 400 according to example embodiments. Referring to FIG. 4, the process of creating a new chat session may include a chat session creation algorithm being initiated 410 at the session agent 112 and identifying certain user attributes 412 as the basis for the chat session creation procedure. The users may begin to be clustered 414 by name/identifier and at least one attribute that creations a commonality among the users in a particular cluster. The learning algorithm may modify the number of users ‘N’ as a threshold needed to create a new chat session 416 based on user ratings of each user over a certain period of time ‘T’. For example, as users are demoted all of their potential registrations may be suspended or revoked and conversely as users increase their ratings it may be the basis for new chat sessions which may increase their rank (i.e., participant, moderator, administrator) and/or their likelihood to be invited to new sessions.

Once a session has been identified by topic and to include a minimum number of required participants, the invitations may be created and sent to the users 418. This may include text messages, emails, automated phone calls, notifications associated with the social networking tools, etc. The users may each accept or reject the invitation 420. The users who reject the invitation or decline to answer may have their score decreased associated with chat recommendations 422, this may lead to fewer offers and a lower rank. Users who accept the chat may be part of a chat schedule proposal 424, a topic selection 426, a process as a selected user to receive an invitation 428, etc. The notifications may be generated 430 and the user ratings 432 may be calculated and applied to the user profiles 434.

According to example embodiments, the clustering of user accounts as indicated in operation 414 of FIG. 4 may further provide a set of operations that organize and setup the clusters for subsequent chat sessions. For example, user profiles being imported to each specified chat sessions may be performed for each user account that retains profile information (e.g., user, interests, demographic information, history, personal information, etc.) and a corresponding keywords index that may be based on their interests from previous documents. For example, the user profile information may be extracted and paired with various synonyms, terms and phrases to increase the likelihood that the profile information is properly matched to specific clusters and/or chat session. Other examples used to generate clusters may include information used to generate key/value pairs corresponding to keywords from the user actions, documents liked/bookmarked and/or other topics, such as diseases or conditions that the user is currently experiencing. User accounts are clustered according to such keywords. In one example, 12 active users with diabetes in their profile may be clustered. The agent may be performing the clustering activity based on the disease names and other user activity from a predefined time period, such as the last two weeks.

Providing incentives to the user accounts may be based on identifying the quality contributors which may be simple, for instance, by counting input instances (i.e., 38 comments in one session) and/or may be based on other operations, such as parsing the content of the user's input via the chat session for specific words and phrases and comparing that information to 5-10 commonly known words associated with a specific topic for relevancy purposes. This may create an automated incentive application that rewards the user accounts after a predetermined number of audited words derived from the commonly known words and being used in separate comment instances, each time a user's input is identified as being relevant, the score may increase for that particular user.

In one example, in order to determine if the user is offering helpful input to the chat session or is being counterproductive (e.g., submitting jokes, generating spam, annoying the participants, overtaking the chat session, etc.), the users may have access to a voting mechanism and/or report button, then the aggregate votes may be used to determine the relevant worth of the user input and the corresponding action taken. This could then initiate a reward badge (i.e., +1 added to score), a warning (i.e., −1 taken from score), etc., and the user continues to disrupt the session based on the other users experiences, they can be reported/removed depending on the importance of the users reporting. For example, a high rated user or session moderator may have complete authority to remove participants. Or, a user with many positive points, such as 10, 20, 100 or more, may be able to report a use and have them removed without delay from the chat session.

According to example embodiments, the user inputted text may be stored, retrieved and processed after the chat session is complete, and the automated agent processing the information may rely on other users' voting input rather than simply natural language processing capabilities or a combination of both type of processing. The result of the processing may be identifying which users should have points rewarded/deducted so a score can be updated to illustrate the accumulated points, which are used to invite the user to more sessions or promote the user to have other privileges, such as moderator to create their own chat session and invite others, administrator to have the right to remove or add people depending on the chat session. etc. The user accounts that are identified as frequenting support groups may be asked to become a moderator if they desire, which may be a user who can help guide the conversation and answer direct questions from other users or a user who dictates who can/cannot attend a session, sets a threshold for attendance (e.g., users with at least 10 points, etc.). User accounts can be clustered by profile information and keyword information. Users in a cluster may require at least one high priority profile dimension (e.g., medication, disease, interest) to be the same prior to qualifying for that particular session. Other profile information, such as personal information, demographics (e.g., income, age, sex, geographical location, etc.) may also be used and considered since the number of clusters may increase with the number of users available, so if the agent application identifies two different groups of people with diabetes (old and young), it may divide those into different groups. Also, keyword information may be the basis for the group session setup. The type of documents that the users reference or have accessed can also be an indicator to further break-up clusters or users. However, if there are only 7 users with a disease, the users will be clustered regardless of demographics or keywords. Clusters are generally of 7-15 participants in size and ideally 10 users. This is not intended to be a static range, as users complete chat sessions and participate in satisfaction surveys, the agent will use reinforcement learning to adjust the optimal number of participants in a chat cluster.

The agent attempts to cluster users into groups of 7-10. This will be adjusted based on the voting received from the satisfaction surveys, which will specifically ask about user satisfaction on the number of users. The agent then takes into account how many users were active in the chat session and adjusts the optimal cluster size over time. If a user commits to and completes a chat session, the likelihood the agent will be able to automatically suggest future chat sessions will increase. The satisfaction survey information may change the optimal cluster size that drives the clustering algorithm. For example, if the number of users is identified with a largely dissatisfied audience, the algorithm for future chats related to the same topic may increase or decrease depending on the number of users present in that session. If user profiles receive enough positive votes from others, then they may be asked to moderate future chat sessions. An administrator may still verify and authorize moderators suggested by the agent application.

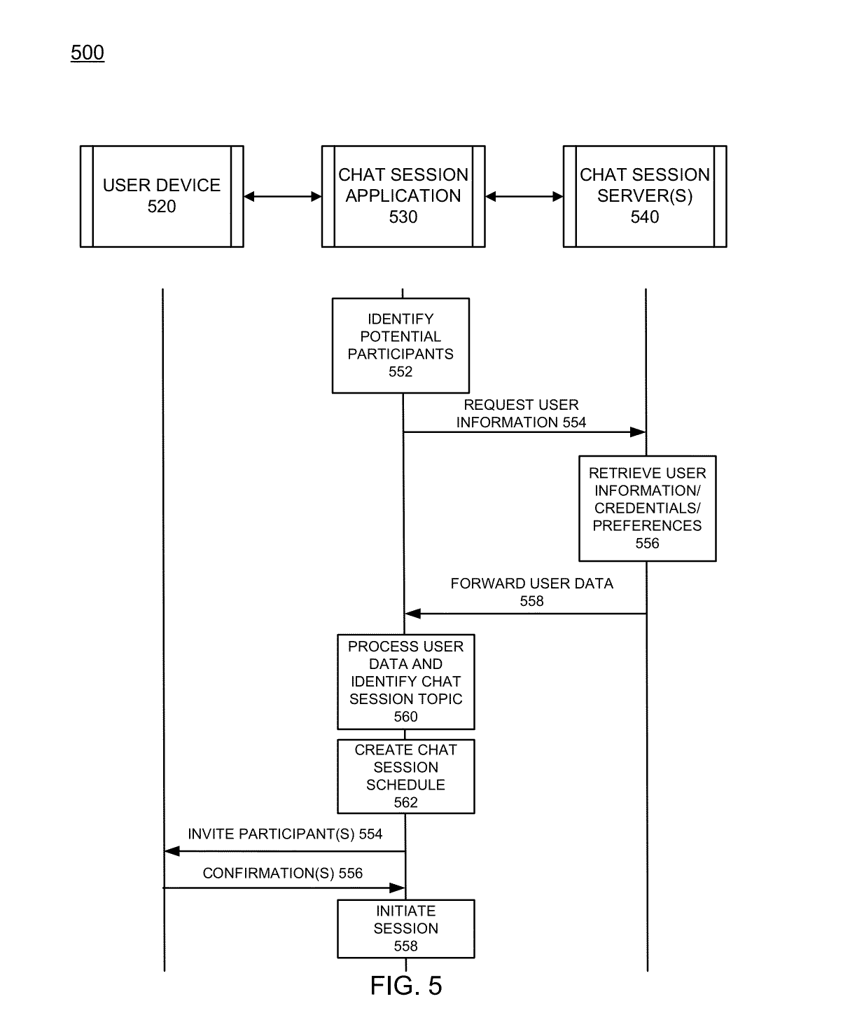

FIG. 5 illustrates a system diagram of a signaling communication session among the user device(s), application and corresponding server(s) according to example embodiments. Referring to FIG. 5, the diagram 500 includes a process of identifying potential participants 552 to be part of the chat session application 530 and requesting the needed information 554. The identities may be retrieved 556 from the chat session server 540 where the database information is stored and retrieved to offer the users based on their corresponding attributes. The user data may be forwarded to the chat session application 558 once it is retrieved. The application 530 may process the user data and identify chat session topics 560 and create corresponding chat session times to conduct the chat 562. The participants may then be invited 554 and the confirmations may be sent 556 for those who desire to be part of the chat session. The session may then initiate automatically at the appropriate time 558.

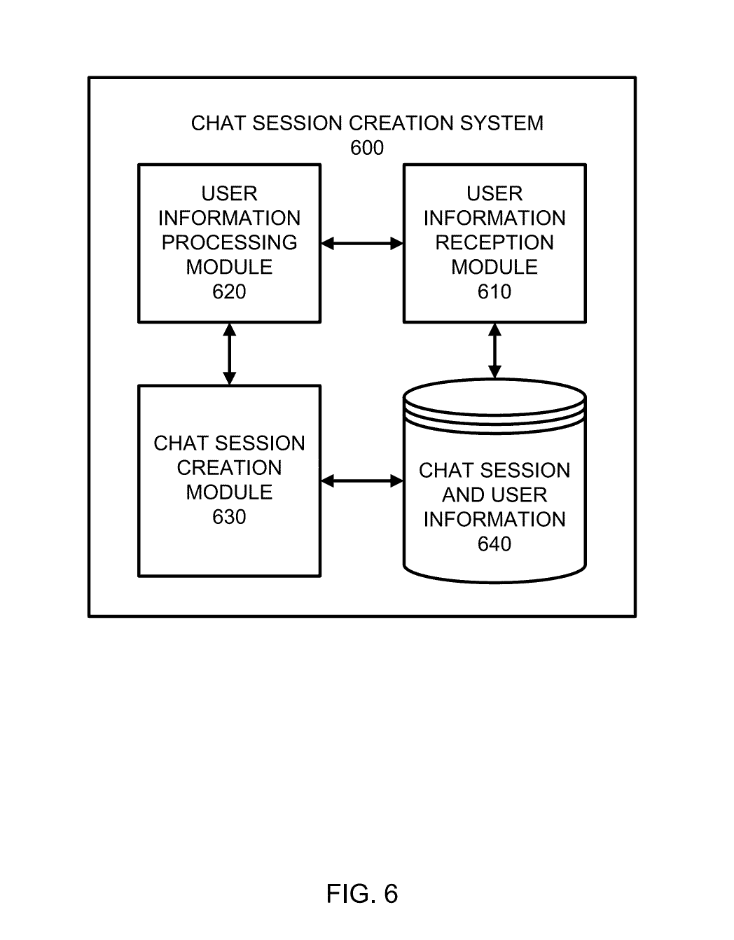

FIG. 6 illustrates an example system diagram of a chat session creation system 600 according to example embodiments. Referring to FIG. 6, the chat creation system may provide identifying a number of users as potential candidates for a chat session via an automated agent application. The user information may be received via module 610 when users make changes or add information within the context of their accounts (e.g., social networking accounts). The information may be stored based on previous user postings, input and other information and previous chat sessions in a database 640. The user information processing module 620 may use the information to retrieve an attribute of each of the users with a common interest identifier from memory (e.g., cancer, diabetes, music, retirement ideas, etc.). The information may be used to create the chat session based on the common interest identifier or other information. The chat session creation module 630 may select a topic for the session and transmit a notification to each of the users to invite them to the chat session.

The automated agent application is installed on a user device of each of the plurality of users, and the automated agent application communicates to a remote chat session server. The attribute of each of the users is retrieved from social network accounts associated with each of the users, and the common interest identifier is based on at least one of user preferences and user submitted information posted on the users' social network accounts. Creating the chat session based on the common interest identifier also includes creating a chat session topic that is based on the common interest identifier, and identifying the users as potential candidates for the chat session also include selecting the users for the chat session who have at least two common interest identifiers which are the same and transmitting the notification to only the users which share two of the same common interest identifiers. The number of common interest identifiers required may be one, two or more. The chat session can be initiated at a proposed time and the input from the users attending the chat session can be logged and identified accordingly. The input may be a blog entry or other shared content and may be processed to determine whether the user should receive positive points, negative points, etc. based on content of the input, and this change can be updated in the user's profile to include a change to the user's total points. The user's profile is updated to receive positive points if the input is related to a chat session topic or negative points if the input is unrelated to a chat session topic.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

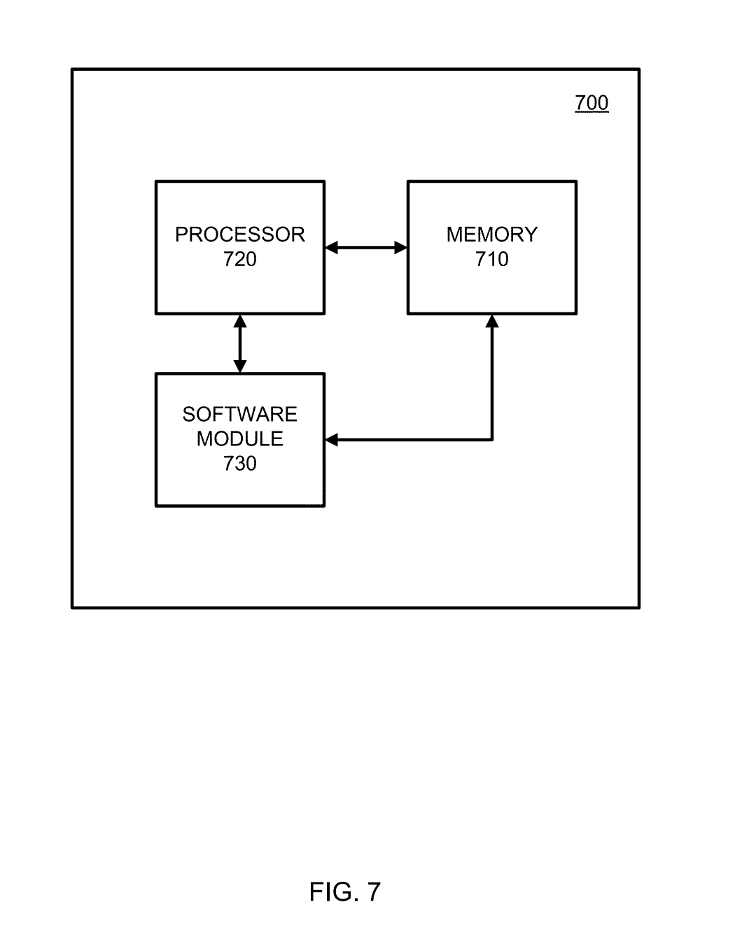

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example FIG. 7 illustrates an example network element 700, which may represent any of the above-described network components of the other figures.

As illustrated in FIG. 7, a memory 710 and a processor 720 may be discrete components of the network entity 700 that are used to execute an application or set of operations. The application may be coded in software in a computer language understood by the processor 720, and stored in a computer readable medium, such as, the memory 710. The computer readable medium may be a non-transitory computer readable medium that includes tangible hardware components in addition to software stored in memory. Furthermore, a software module 730 may be another discrete entity that is part of the network entity 700, and which contains software instructions that may be executed by the processor 720. In addition to the above noted components of the network entity 700, the network entity 700 may also have a transmitter and receiver pair configured to receive and transmit communication signals (not shown).

Although an exemplary embodiment of the system, method, and computer readable medium of the present invention has been illustrated in the accompanied drawings and described in the foregoing detailed description, it will be understood that the invention is not limited to the embodiments disclosed, but is capable of numerous rearrangements, modifications, and substitutions without departing from the spirit or scope of the invention as set forth and defined by the following claims. For example, the capabilities of the system of FIG. 6 can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of the invention, as generally described and illustrated in the figures herein, may be arranged and designed in a wide variety of different configurations. Thus, the detailed description of the embodiments is not intended to limit the scope of the invention as claimed, but is merely representative of selected embodiments of the invention.

One having ordinary skill in the art will readily understand that the invention as discussed above may be practiced with steps in a different order, and/or with hardware elements in configurations that are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method comprising:
identifying a plurality of users as potential candidates for a chat session via an automated agent application;
retrieving at least one attribute of each of the plurality of users with a common interest identifier from memory;
creating the chat session based on the common interest identifier; and
transmitting a notification to each of the plurality of users to invite them to the chat session.

2. The method of claim 1, wherein the automated agent application is installed on a user device of each of the plurality of users, and wherein the automated agent application communicates to a remote chat session server.

3. The method of claim 1, wherein the at least one attribute of each of the plurality of users is retrieved from social network accounts associated with each of the plurality of users, and wherein the common interest identifier is based on at least one of user preferences and user submitted information posted on the users' social network accounts.

4. The method of claim 1, wherein creating the chat session based on the common interest identifier comprises creating a chat session topic that is based on the common interest identifier, and
wherein identifying the plurality of users as potential candidates for the chat session further comprises selecting the users for the chat session who have at least two common interest identifiers which are the same and transmitting the notification to only the users which share two of the same common interest identifiers.

5. The method of claim 1, further comprising:
initiating the chat session at a proposed time;
receiving input from at least one of the plurality of users attending the chat session;
processing the input to determine whether the at least one user should receive at least one of positive points and negative points based on content of the input; and
updating the at least one user's profile to include a change to the user's total points.

6. The method of claim 5, wherein the at least one user's profile is updated to receive positive points if the input is related to a chat session topic.

7. The method of claim 5, wherein the at least one user's profile is updated to receive negative points if the input is unrelated to a chat session topic.

8. An apparatus comprising:
a processor configured to
identify a plurality of users as potential candidates for a chat session via an automated agent application;
retrieve at least one attribute of each of the plurality of users with a common interest identifier from a memory,
create the chat session based on the common interest identifier; and
a transmitter configured to transmit a notification to each of the plurality of users to invite them to the chat session.

9. The apparatus of claim 8, wherein the automated agent application is installed on a user device of each of the plurality of users, and wherein the automated agent application communicates to a remote chat session server.

10. The apparatus of claim 8, wherein the at least one attribute of each of the plurality of users is retrieved from social network accounts associated with each of the plurality of users, and wherein the common interest identifier is based on at least one of user preferences and user submitted information posted on the users' social network accounts.

11. The apparatus of claim 8, wherein the process creates the chat session based on the common interest identifier by further being configured to
create a chat session topic that is based on the common interest identifier, and
wherein the plurality of users are identified as potential candidates for the chat session by selecting the users for the chat session who have at least two common interest identifiers which are the same, and
wherein the transmitter is further configured to transmit the notification to only the users which share two of the same common interest identifiers.

12. The apparatus of claim 8, wherein the processor is further configured to initiate the chat session at a proposed time and a receiver is configured to receive input from at least one of the plurality of users attending the chat session, and
wherein the processor is further configured to process the input to determine whether the at least one user should receive at least one of positive points and negative points based on content of the input, and update the at least one user's profile to include a change to the user's total points.

13. The apparatus of claim 12, wherein the at least one user's profile is updated to receive positive points if the input is related to a chat session topic.

14. The apparatus of claim 12, wherein the at least one user's profile is updated to receive negative points if the input is unrelated to a chat session topic.

15. A non-transitory computer readable storage medium configured to store instructions that when executed cause a processor to perform:
identifying a plurality of users as potential candidates for a chat session via an automated agent application;
retrieving at least one attribute of each of the plurality of users with a common interest identifier from memory;
creating the chat session based on the common interest identifier; and
transmitting a notification to each of the plurality of users to invite them to the chat session.

16. The non-transitory computer readable storage medium of claim 15, wherein the automated agent application is installed on a user device of each of the plurality of users, and wherein the automated agent application communicates to a remote chat session server.

17. The non-transitory computer readable storage medium of claim 15, wherein the at least one attribute of each of the plurality of users is retrieved from social network accounts associated with each of the plurality of users, and wherein the common interest identifier is based on at least one of user preferences and user submitted information posted on the users' social network accounts.

18. The non-transitory computer readable storage medium of claim 15, wherein creating the chat session based on the common interest identifier comprises creating a chat session topic that is based on the common interest identifier, and
wherein identifying the plurality of users as potential candidates for the chat session further comprises selecting the users for the chat session who have at least two common interest identifiers which are the same and transmitting the notification to only the users which share two of the same common interest identifiers.

19. The non-transitory computer readable storage medium of claim 15, wherein the processor is further configured to perform:
initiating the chat session at a proposed time;
receiving input from at least one of the plurality of users attending the chat session;
processing the input to determine whether the at least one user should receive at least one of positive points and negative points based on content of the input; and
updating the at least one user's profile to include a change to the user's total points.

20. The non-transitory computer readable storage medium of claim 19, wherein the at least one user's profile is updated to receive positive points if the input is related to a chat session topic, and wherein the at least one user's profile is updated to receive negative points if the input is unrelated to a chat session topic.
